(19) United States
(12) Patent Application Publication
(10) Pub. No.: US 2017/0314572 A1
(43) Pub. Date: Nov. 2, 2017

(54) IMPELLER SHROUD FOR A COMPRESSOR

(71) Applicant: DRESSER-RAND COMPANY, Olean, NY (US)

(72) Inventors: Kyle Badeau, Seattle, WA (US); Kirk Ryan Lupkes, Renton, WA (US)

(21) Appl. No.: 15/597,231

(22) Filed: May 17, 2017

Related U.S. Application Data
(63) Continuation-in-part of application No. PCT/US2016/023943, filed on Mar. 24, 2016.
(60) Provisional application No. 62/139,055, filed on Mar. 27, 2015.
(60) Provisional application No. 62/139,064, filed on Mar. 27, 2015.

(51) Int. Cl. F04D 29/42; F04D 29/16; F04D 29/62; F04D 17/10; F01D 25/24; F01D 11/08

(52) U.S. Cl. CPC F04D 29/4206; F04D 29/622; F04D 17/10; F04D 29/162; F05B 2230/30; F01D 11/08; F01D 25/24; F05B 2230/90; F05B 2240/11; F05B 2260/20; F05B 2210/402

(57) ABSTRACT

A shroud for a compressor is provided. The shroud may include a first annular portion constructed of a first material, a second annular portion coupled to the first annular portion and constructed of a second material, and a first coating disposed on the first annular portion and constructed of a third material. At least one of the first material, the second material, and the third material may be a different material from at least one other of the first material, the second material, and the third material.

### CROSS-REFERENCE TO RELATED APPLICATIONS

The present application is a continuation-in-part of PCT Patent Application having Serial No. PCT/US2016/023943, filed on Mar. 24, 2016, which claims the benefit of U.S. Provisional Patent Application having Ser. No. 62/139,055, filed on Mar. 27, 2015, and U.S. Provisional Patent Application having Ser. No. 62/139,064, filed on Mar. 27, 2015. The aforementioned patent applications are hereby incorporated by reference in their entirety into the present application.

### STATEMENT REGARDING FEDERALLY SPONSORED RESEARCH OR DEVELOPMENT

This invention was made with government support under Government Contract No. DOE-DE-FE0000493 awarded by the U.S. Department of energy. The government has certain rights in the invention.

### BACKGROUND

Compressors and systems incorporating compressors have been developed and are often utilized in a myriad of industrial processes (e.g., petroleum refineries, offshore oil production platforms, and subsea process control systems). Conventional compressors may be configured to compress a process fluid by applying kinetic energy to the process fluid to transport the process fluid from a low pressure environment to a high pressure environment. The compressed process fluid discharged from the compressors may be utilized to efficiently perform work or operate one or more downstream processes. Improvements in the efficiency of conventional compressors has increased the application of the compressors at various oil production sites. Many of the oil production sites (e.g., offshore), however, may be constrained or limited in space. Accordingly, there is an increased interest and demand for smaller and lighter compressors, or compact compressors. In addition to the foregoing, it is often desirable that the compact compressors be capable of achieving higher compression ratios for increased production while maintaining a compact footprint.

To achieve the higher compression ratios, conventional compact compressors may often utilize open impellers to accelerate or apply kinetic energy to the process fluid, as the open impellers may often be relatively easier to manufacture. While the open impellers may be relatively easier to manufacture, conventional compact compressors utilizing the open impellers may exhibit decreased performance and/or efficiencies. For example, as the open impellers are rotated to accelerate the process fluid, a portion of the process fluid may flow or leak out of the open impellers through clearances defined between the open impellers and a casing of the compact compressor, thereby reducing the efficiency thereof.

In view of the foregoing, conventional compact compressors may often utilize separate shrouds coupled to the casing of the compact compressors to reduce or eliminate the clearances between the casing and the impeller. However, at the rotational speeds necessary to accelerate the process fluid and achieve the higher compression ratios, radial and/or axial growth of the casing and the shroud coupled therewith may increase the clearances between the shroud and the impeller. For example, the compression of the process fluid to the higher compression ratios may generate heat (e.g., heat of compression) proximal one or more portions of the casing, and the heat of compression may subsequently result in radial and/or axial thermal growth of the casing and the shroud coupled therewith. The radial and/or axial thermal growth of the casing and the shroud may correspondingly increase the clearances between the shroud and the impeller, thereby resulting in decreased performance and/or efficiency.

In addition to the radial and/or axial thermal growth of the casing and the shroud, the rotating impeller may contact the static shroud during transient conditions at different time points and locations, thereby leading to loss of material from the impeller tips. Further, flow conditions may vary through the impeller flowpath from inlet to exit, thereby generating high static and dynamic loads leading to erosion of the shroud surfaces bounding the impeller flowpath. Attempts to mitigate the loss of material from the impeller tips contacting the shroud have included adding an abradable coating to the shroud or constructing the shroud from a complaint material. However, such an abradable coating or a compliant material utilized to reduce damage to the impeller tips resulting from contact with the shroud may not be suitable for reducing erosion of the shroud surfaces or radial and/or axial thermal growth of the shroud and the casing. As the locations susceptible to damage resulting from contact with the impeller tips may differ from the locations of the shroud susceptible to damage from erosion risks or thermal growth, it may be difficult to find a single material suitable for application across the entire impeller flowpath that addresses the abovementioned drawbacks.

What is needed, then, is an improved shroud for controlling clearances between the shroud and an impeller in compact compressors.

### SUMMARY

Embodiments of this disclosure may provide a shroud for a compressor. The shroud may include a first annular portion constructed of a first material, a second annular portion coupled to the first annular portion and constructed of a second material, and a first coating disposed on the first annular portion and constructed of a third material. At least one of the first material, the second material, and the third material may be a different material from at least one other of the first material, the second material, and the third material.

Embodiments of the disclosure may also provide another shroud for a compressor. The shroud may include a first annular portion, a second annular portion, a first coating, and a second coating. The first annular portion may be constructed of a first material and may include an inner annular member, an outer annular member, ad a bridge member. The inner annular member may have a first inner annular member end portion and a second inner annular member end portion and an inner annular surface extending between the first inner annular member end portion and the second inner annular member end portion. The outer annular member may have a first outer annular member end portion and a second outer annular member end portion and an outer annular surface extending between the first outer annular member end portion and the second outer annular member end portion. The outer annular member may be configured to couple the shroud with a casing of the compressor. The bridge member may extend radially between the second inner annular member end portion and the second outer annular member end portion. The second annular portion may be constructed of a second material and coupled to the first annular portion. The second annular portion may include an inner annular surface. The first coating may be constructed of a third material and disposed on the inner annular surface of the inner annular member. The second coating may be constructed of a fourth material and disposed on the inner annular surface of the second annular portion. At least one of the first material, the second material, the third material, and the fourth material may be a different material from at least one other of the first material, the second material, the third material, and the fourth material.

Embodiments of the compressor may further provide a compressor. The compressor may include a casing, rotary shaft, an impeller, and a shroud. The rotary shaft may be disposed in the casing and configured to be driven by a driver. The impeller may be coupled with and configured to be driven by the rotary shaft. The impeller may include an eye, a tip, and a plurality of blades forming a plurality of flowpaths extending between the eye and the tip of the impeller. The shroud may be disposed proximal the impeller and may include a first annular portion constructed of a first material and disposed proximal the eye of the impeller. The shroud may also include a second annular portion coupled to the first annular portion and constructed of a second material. The second annular portion may be disposed proximal the tip of the impeller. The shroud may further include a first coating disposed on the first annular portion and constructed of a third material. At least one of the first material, the second material, and the third material may be a different material from at least one other of the first material, the second material, and the third material.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a schematic view of an exemplary compression system including a compressor, according to one or more embodiments disclosed.

FIG. 2A illustrates a partial, cross-sectional view of an exemplary compressor that may be included in the compression system of FIG. 1, according to one or more embodiments disclosed.

FIG. 2B illustrates an enlarged view of the portion of the compressor indicated by the box labeled 2B of FIG. 2A, according to one or more embodiments disclosed.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

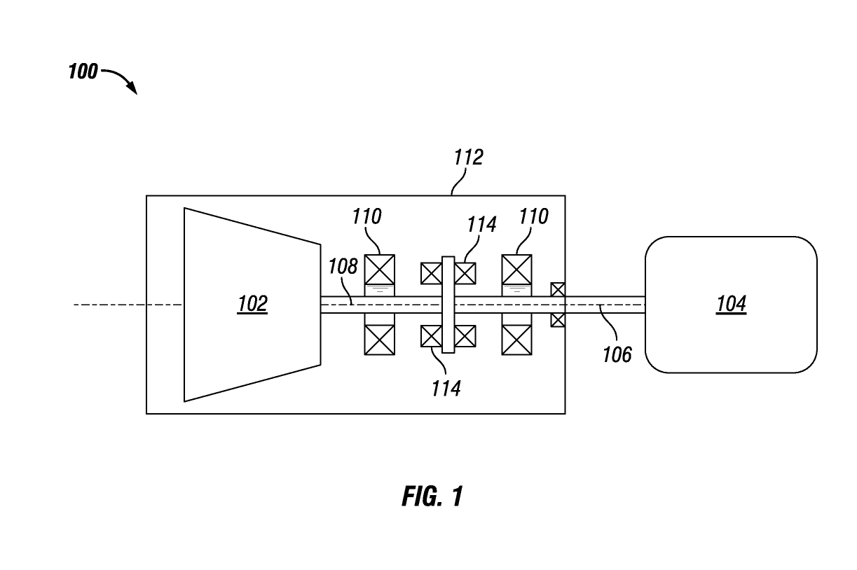

FIG. 1 illustrates a schematic view of an exemplary compression system 100, according to one or more embodiments. The compression system 100 may include, amongst other components, one or more compressors 102 (one is shown), a driver 104, and a drive shaft 106 configured to operatively couple the compressor 102 with the driver 104. The compression system 100 may be configured to compress or pressurize a process fluid. For example, as further described herein, the driver 104 may be configured to drive the compressor 102 via the drive shaft 106 to compress the process fluid. In an exemplary embodiment, the compression system 100 may have a compression ratio of at least about 6:1 or greater. For example, the compression system 100 may compress the process fluid to a compression ratio of about 3:1, about 3.1:1, about 3.2:1, about 3.3:1, about 3.4:1, about 3.5:1, about 3.6:1, about 3.7:1, about 3.8:1, about 3.9:1, about 4:1, about 4.1:1, about 4.2:1, about 4.3:1, about 4.4:1, about 4.5:1, about 4.6:1, about 4.7:1, about 4.8:1, about 4.9:1, about 5:1, about 5.1:1, about 5.2:1, about 5.3:1, about 5.4:1, about 5.5:1, about 5.6:1, about 5.7:1, about 5.8:1, about 5.9:1, about 6:1, about 6.1:1, about 6.2:1, about 6.3:1, about 6.4:1, about 6.5:1, about 6.6:1, about 6.7:1, about 6.8:1, about 6.9:1, about 7:1, about 7.1:1, about 7.2:1, about 7.3:1, about 7.4:1, about 7.5:1, about 7.6:1, about 7.7:1, about 7.8:1, about 7.9:1, about 8:1, about 8.1:1, about 8.2:1, about 8.3:1, about 8.4:1, about 8.5:1, about 8.6:1, about 8.7:1, about 8.8:1, about 8.9:1, about 9:1, about 9.1:1, about 9.2:1, about 9.3:1, about 9.4:1, about 9.5:1, about 9.6:1, about 9.7:1, about 9.8:1, about 9.9:1, about 10:1, about 10.1:1, about 10.2:1, about 10.3:1, about 10.4:1, about 10.5:1, about 10.6:1, about 10.7:1, about 10.8:1, about 10.9:1, about 11:1, about 11.1:1, about 11.2:1, about 11.3:1, about 11.4:1, about 11.5:1, about 11.6:1, about 11.7:1, about 11.8:1, about 11.9:1, about 12:1, about 12.1:1, about 12.2:1, about 12.3:1, about 12.4:1, about 12.5:1, about 12.6:1, about 12.7:1, about 12.8:1, about 12.9:1, about 13:1, about 13.1:1, about 13.2:1, about 13.3:1, about 13.4:1, about 13.5:1, about 13.6:1, about 13.7:1, about 13.8:1, about 13.9:1, about 14:1, or greater.

The compressor 102 may be a direct-inlet centrifugal compressor. The direct-inlet centrifugal compressor may be, for example, a version of a Dresser-Rand Pipeline Direct Inlet (PDI) centrifugal compressor manufactured by the Dresser-Rand Company of Olean, N.Y. The compressor 102 may have a center-hung rotor configuration or an overhung rotor configuration, as illustrated in FIG. 1. In an exemplary embodiment, the compressor 102 may be an axial-inlet centrifugal compressor. In another embodiment, the compressor 102 may be a radial-inlet centrifugal compressor. As previously discussed, the compression system 100 may include one or more compressors 102. For example, the compression system 100 may include a plurality of compressors (not shown). In another example, illustrated in FIG. 1, the compression system 100 may include a single compressor 102. The compressor 102 may be a supersonic compressor or a subsonic compressor. In at least one embodiment, the compression system 100 may include a plurality of compressors (not shown), and at least one compressor of the plurality of compressors is a subsonic compressor. In another embodiment, illustrated in FIG. 1, the compression system 100 includes a single compressor 102, and the single compressor 102 is a supersonic compressor.

The compressor 102 may include one or more stages (not shown). In at least one embodiment, the compressor 102 may be a single-stage compressor. In another embodiment, the compressor 102 may be a multi-stage centrifugal compressor. Each stage (not shown) of the compressor 102 may be a subsonic compressor stage or a supersonic compressor stage. In an exemplary embodiment, the compressor 102 may include a single supersonic compressor stage. In another embodiment, the compressor 102 may include a plurality of subsonic compressor stages. In yet another embodiment, the compressor 102 may include a subsonic compressor stage and a supersonic compressor stage. Any one or more stages of the compressor 102 may have a compression ratio greater than about 1:1. For example, any one or more stages of the compressor 102 may have a compression ratio of about 1.1:1, about 1.2:1, about 1.3:1, about 1.4:1, about 1.5:1, about 1.6:1, about 1.7:1, about 1.8:1, about 1.9:1, about 2:1, about 2.1:1, about 2.2:1, about 2.3:1, about 2.4:1, about 2.5:1, about 2.6:1, about 2.7:1, about 2.8:1, about 2.9:1, about 3:1, about 3.1:1, about 3.2:1, about 3.3:1, about 3.4:1, about 3.5:1, about 3.6:1, about 3.7:1, about 3.8:1, about 3.9:1, about 4:1, about 4.1:1, about 4.2:1, about 4.3:1, about 4.4:1, about 4.5:1, about 4.6:1, about 4.7:1, about 4.8:1, about 4.9:1, about 5:1, about 5.1:1, about 5.2:1, about 5.3:1, about 5.4:1, about 5.5:1, about 5.6:1, about 5.7:1, about 5.8:1, about 5.9:1, about 6:1, about 6.1:1, about 6.2:1, about 6.3:1, about 6.4:1, about 6.5:1, about 6.6:1, about 6.7:1, about 6.8:1, about 6.9:1, about 7:1, about 7.1:1, about 7.2:1, about 7.3:1, about 7.4:1, about 7.5:1, about 7.6:1, about 7.7:1, about 7.8:1, about 7.9:1, about 8.0:1, about 8.1:1, about 8.2:1, about 8.3:1, about 8.4:1, about 8.5:1, about 8.6:1, about 8.7:1, about 8.8:1, about 8.9:1, about 9:1, about 9.1:1, about 9.2:1, about 9.3:1, about 9.4:1, about 9.5:1, about 9.6:1, about 9.7:1, about 9.8:1, about 9.9:1, about 10:1, about 10.1:1, about 10.2:1, about 10.3:1, about 10.4:1, about 10.5:1, about 10.6:1, about 10.7:1, about 10.8:1, about 10.9:1, about 11:1, about 11.1:1, about 11.2:1, about 11.3:1, about 11.4:1, about 11.5:1, 11 3.6:1, about 11.7:1, about 11.8:1, about 11.9:1, about 12:1, about 12.1:1, about 12.2:1, about 12.3:1, about 12.4:1, about 12.5:1, about 12.6:1, about 12.7:1, about 12.8:1, about 12.9:1, about 13:1, about 13.1:1, about 13.2:1, about 13.3:1, about 13.4:1, about 13.5:1, about 13.6:1, about 13.7:1, about 13.8:1, about 13.9:1, about 14:1, or greater. In an exemplary embodiment, the compressor 102 may include a plurality of compressor stages, where a first stage (not shown) of the plurality of compressor stages may have a compression ratio of about 1.75:1 and a second stage (not shown) of the plurality of compressor stages may have a compression ratio of about 6.0:1.

The driver 104 may be configured to provide the drive shaft 106 with rotational energy. The drive shaft 106 may be integral or coupled with a rotary shaft 108 of the compressor 102 such that the rotational energy of the drive shaft 106 may be transmitted to the rotary shaft 108. The drive shaft 106 of the driver 104 may be coupled with the rotary shaft 108 via a gearbox (not shown) having a plurality of gears configured to transmit the rotational energy of the drive shaft 106 to the rotary shaft 108 of the compressor 102. Accordingly, the drive shaft 106 and the rotary shaft 108 may spin at the same speed, substantially similar speeds, or differing speeds and rotational directions via the gearbox. The driver 104 may be a motor, such as a permanent magnetic electric motor, and may include a stator (not shown) and a rotor (not shown). It should be appreciated, however, that other embodiments may employ other types of motors including, but not limited to, synchronous motors, induction motors, and brushed DC motors, or the like. The driver 104 may also be a hydraulic motor, an internal combustion engine, a steam turbine, a gas turbine, or any other device capable of driving or rotating the rotary shaft 108 of the compressor 102.

The compression system 100 may include one or more radial bearings 110 directly or indirectly supported by a housing 112 of the compression system 100. The radial bearings 110 may be configured to support the drive shaft 106 and/or the rotary shaft 108. The radial bearings 110 may be oil film bearings. The radial bearings 110 may also be magnetic bearings, such as active magnetic bearings, passive magnetic bearings, or the like. The compression system 100 may also include one or more axial thrust bearings 114 disposed adjacent the rotary shaft 108 and configured to control the axial movement of the rotary shaft 108. The axial thrust bearings 114 may be magnetic bearings configured to at least partially support and/or counter thrust loads or forces generated by the compressor 102.

The process fluid pressurized, circulated, contained, or otherwise utilized in the compression system 100 may be a fluid in a liquid phase, a gas phase, a supercritical state, a subcritical state, or any combination thereof. The process fluid may be a mixture, or process fluid mixture. The process fluid may include one or more high molecular weight process fluids, one or more low molecular weight process fluids, or any mixture or combination thereof. As used herein, the term “high molecular weight process fluids” refers to process fluids having a molecular weight of about 30 grams per mole (g/mol) or greater. Illustrative high molecular weight process fluids may include, but are not limited to, hydrocarbons, such as ethane, propane, butanes, pentanes, and hexanes. Illustrative high molecular weight process fluids may also include, but are not limited to, carbon dioxide (CO₂) or process fluid mixtures containing carbon dioxide. As used herein, the term “low molecular weight process fluids” refers to process fluids having a molecular weight less than about 30 g/mol. Illustrative low molecular weight process fluids may include, but are not limited to, air, hydrogen, methane, or any combination or mixtures thereof.

In an exemplary embodiment, the process fluid or the process fluid mixture may be or include carbon dioxide. The amount of carbon dioxide in the process fluid or the process fluid mixture may be at least about 80%, at least about 85%, at least about 90%, at least about 95%, at least about 96%, at least about 97%, at least about 98%, at least about 99%, or greater by volume. Utilizing carbon dioxide as the process fluid or as a component or part of the process fluid mixture in the compression system 100 may provide one or more advantages. For example, carbon dioxide may provide a readily available, inexpensive, non-toxic, and non-flammable process fluid. In another example, the relatively high working pressure of applications utilizing carbon dioxide may allow the compression system 100 incorporating carbon dioxide (e.g., as the process fluid or as part of the process fluid mixture) to be relatively more compact than compression systems incorporating other process fluids (e.g., process fluids not including carbon dioxide). Additionally, the high density and high heat capacity or volumetric heat capacity of carbon dioxide with respect to other process fluids may make carbon dioxide more “energy dense.” Accordingly, a relative size of the compression system 100 and/or the components thereof may be reduced without reducing the performance of the compression system 100.

The carbon dioxide may be of any particular type, source, purity, or grade. For example, industrial grade carbon dioxide may be utilized as the process fluid without departing from the scope of the disclosure. Further, as previously discussed, the process fluids may be a mixture, or process fluid mixture. The process fluid mixture may be selected for one or more desirable properties of the process fluid mixture within the compression system 100. For example, the process fluid mixture may include a mixture of a liquid absorbent and carbon dioxide (or a process fluid containing carbon dioxide) that may enable the process fluid mixture to be compressed to a relatively higher pressure with less energy input than compressing carbon dioxide (or a process fluid containing carbon dioxide) alone.

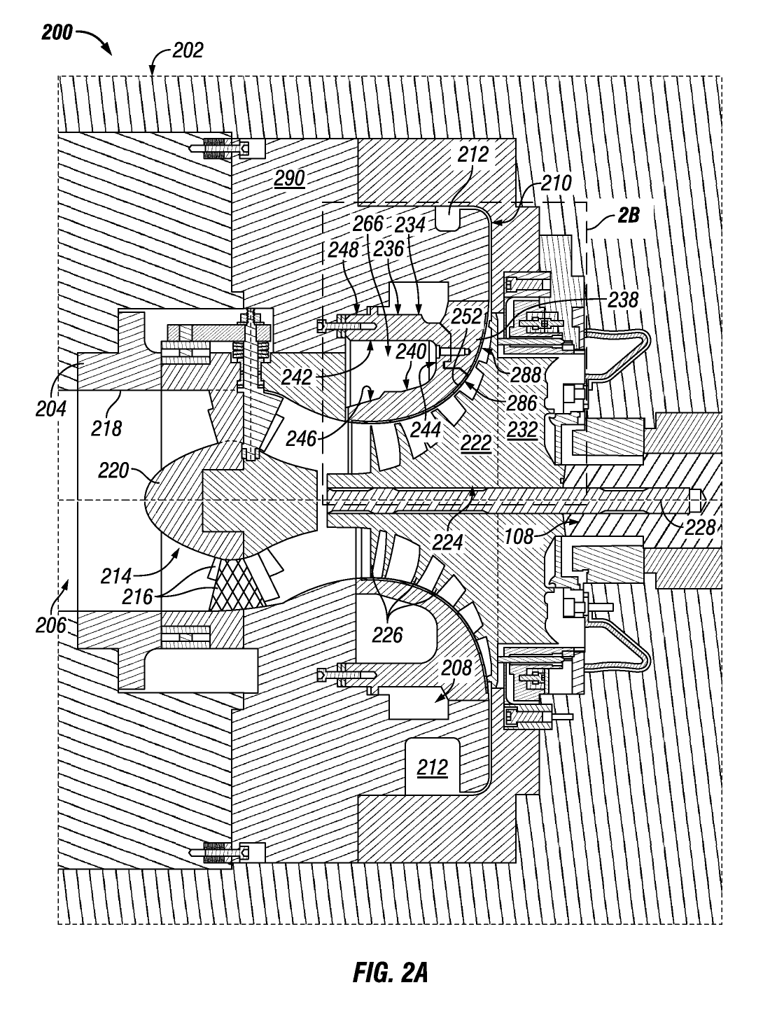

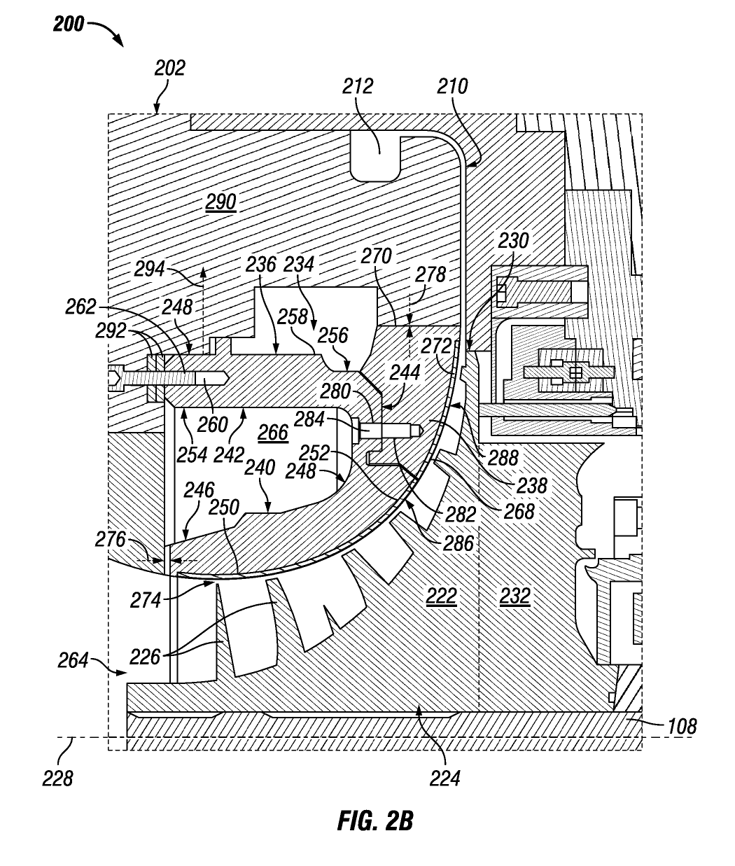

FIG. 2A illustrates a partial, cross-sectional view of an exemplary compressor 200 that may be included in the compression system 100 of FIG. 1, according to one or more embodiments. FIG. 2B illustrates an enlarged view of the portion of the compressor 200 indicated by the box labeled 2B of FIG. 2A, according to one or more embodiments. As illustrated in FIG. 2A, the compressor 200 may include a casing 202 and an inlet 204 (e.g., an axial inlet). The casing 202 and the inlet 204 may at least partially define a fluid pathway of the compressor 200 through which the process fluid may flow. The fluid pathway may include an inlet passageway 206 configured to receive the process fluid, an impeller cavity 208 fluidly coupled with the inlet passageway 206, a diffuser 210 (e.g., static diffuser) fluidly coupled with the impeller cavity 208, and a collector or volute 212 fluidly coupled with the diffuser 210. The casing 202 may be configured to support and/or protect one or more components of the compressor 200. The casing 202 may also be configured to contain the process fluid flowing through one or more portions or components of the compressor 200.

As illustrated in FIG. 2A, the compressor 200 may include an inlet guide vane assembly 214 configured to condition a process fluid flowing through the inlet passageway 206 to achieve predetermined or desired fluid properties and/or fluid flow attributes. Such fluid properties and/or fluid flow attributes may include flow pattern (e.g., swirl distribution), velocity, flow rate, pressure, temperature, and/or any suitable fluid property and fluid flow attribute to enable the compressor 200 to function as described herein. The inlet guide vane assembly 214 may include one or more inlet guide vanes 216 disposed in the inlet passageway 206 and configured to impart the one or more fluid properties and/or fluid flow attributes to the process fluid flowing through the inlet passageway 206. The inlet guide vanes 216 may also be configured to vary the one or more fluid properties and/or fluid flow attributes of the process fluid flowing through the inlet passageway 206. For example, respective portions of the inlet guide vanes 216 may be moveable (e.g., adjustable) to vary the one or more fluid properties and/or fluid flow attributes (e.g., swirl, velocity, mass flowrate, etc.) of the process fluid flowing through the inlet passageway 206. In an exemplary embodiment, the inlet guide vanes 216 may be configured to move or adjust within the inlet passageway 206, as disclosed in U.S. Pat. No. 8,632,302, the subject matter of which is incorporated by reference herein to the extent consistent with the present disclosure.

In another embodiment, illustrated in FIG. 2A, the inlet guide vanes 216 may extend through the inlet passageway 206 from an inner surface 218 of the inlet 204 to a hub 220 of the inlet guide vane assembly 214. The inlet guide vanes 216 may be circumferentially spaced at substantially equal intervals or at varying intervals about the hub 220. The inlet guide vanes 216 may be airfoil shaped, streamline shaped, or otherwise shaped and configured to at least partially impart the one or more fluid properties on the process fluid flowing through the inlet passageway 206.

The compressor 200 may include an impeller 222 disposed in the impeller cavity 208. The impeller 222 may have a hub 224 and a plurality of blades 226 extending from the hub 224. In an exemplary embodiment, illustrated in FIG. 2A, the impeller 222 may be an open or “unshrouded” impeller. In another embodiment, the impeller 222 may be a shrouded impeller. The impeller 222 may be configured to rotate about a longitudinal axis 228 of the compressor 200 to increase the static pressure and/or the velocity of the process fluid flowing therethrough. For example, the hub 224 of the impeller 222 may be coupled with the rotary shaft 108, and the impeller 222 may be driven or rotated by the driver 104 (see FIG. 1) via the rotary shaft 108 and the drive shaft 106. The rotation of the impeller 222 may draw the process fluid into the compressor 200 via the inlet passageway 206. The rotation of the impeller 222 may further draw the process fluid to and through the impeller 222 and accelerate the process fluid to a tip 230 (see FIG. 2B) of the impeller 222, thereby increasing the static pressure and/or the velocity of the process fluid. The plurality of blades 226 may be configured to impart the static pressure (potential energy) and/or the velocity (kinetic energy) to the process fluid to raise the velocity of the process fluid and direct the process fluid from the impeller 222 to the diffuser 210 fluidly coupled therewith. The diffuser 210 may be configured to convert kinetic energy of the process fluid from the impeller 222 into increased static pressure.

In one or more embodiments, the process fluid at the tip 230 of the impeller 222 may be subsonic and have an absolute Mach number less than one. For example, the process fluid at the tip 230 of the impeller 222 may have an absolute Mach number less than 1, less than 0.9, less than 0.8, less than 0.7, less than 0.6, less than 0.5, less than 0.4, less than 0.3, less than 0.2, or less than 0.1. Accordingly, in such embodiments, the compressors 102, 200 discussed herein may be “subsonic,” as the impeller 222 may be configured to rotate about the longitudinal axis 228 at a speed sufficient to provide the process fluid at the tip 230 thereof with an absolute Mach number of less than one.

In one or more embodiments, the process fluid at the tip 230 of the impeller 222 may be supersonic and have an absolute Mach number of one or greater. For example, the process fluid at the tip 230 of the impeller 222 may have an absolute Mach number of at least 1, at least 1.1, at least 1.2, at least 1.3, at least 1.4, or at least 1.5. Accordingly, in such embodiments, the compressors 102, 200 discussed herein are said to be “supersonic,” as the impeller 222 may be configured to rotate about the longitudinal axis 228 at a speed sufficient to provide the process fluid at the tip 230 thereof with an absolute Mach number of one or greater or with a fluid velocity greater than the speed of sound. In a supersonic compressor or a stage thereof, the rotational or tip speed of the impeller 222 may be about 500 meters per second (m/s) or greater. For example, the tip speed of the impeller 222 may be about 510 m/s, about 520 m/s, about 530 m/s, about 540 m/s, about 550 m/s, about 560 m/s, or greater.

As illustrated in FIGS. 2A and 2B, the compressor 200 may include a balance piston 232 configured to balance an axial thrust generated by the impeller 222 during one or more modes of operating the compressor 200. In at least one embodiment, the balance piston 232 and the impeller 222 may be separate components. For example, the balance piston 232 and the impeller 222 may be separate annular components coupled with one another. In another embodiment, illustrated in FIGS. 2A and 2B, the balance piston 232 may be integral with the impeller 222, such that the balance piston 232 and the impeller 222 may be formed from a single or unitary annular piece.

As illustrated in FIGS. 2A and 2B, the compressor 200 may also include a shroud 234 disposed proximal the impeller 222. The shroud 234 may be annular in form and may be constructed from a plurality of annular portions (two shown 236, 238) coupled with one another. For example, as shown in FIGS. 2A and 2B, the shroud 234 may include a first annular portion 236 coupled with a second annular portion 238. In another embodiment, the shroud 234 may be constructed from three annular portions coupled with one another. In another embodiment, the shroud 234 may be constructed from four or more annular portions coupled with one another.

The first annular portion 236 may include an inner annular member 240, an outer annular member 242, and a bridge member 244 extending radially therebetween. The inner annular member 240 may include a first inner annular member end portion 246 and a second inner annular member end portion 248 and an inner annular surface 250 extending therebetween. The inner annular member 240 may be contoured between the first inner annular member end portion 246 and the second inner annular member end portion 248 thereof such that the inner annular surface 250 thereof may be substantially aligned with a silhouette of the impeller 222 or a silhouette of the plurality of blades 226. As shown most clearly in FIG. 2B, the inner annular surface 250 may define a recess 252 extending substantially between the first inner annular member end portion 246 and the second inner annular member end portion 248.

The outer annular member 242 may include a first outer annular member end portion 254 and a second outer annular member end portion 256 and an outer annular surface 258 extending therebetween. The bridge member 244 may extend radially between the second inner annular member end portion 248 and the second outer annular member end portion 256. The shroud 234 may be mounted or coupled with the casing 202 via the outer annular member 242. For example, as illustrated in FIG. 2B, the shroud 234 may be coupled with the casing 202 via the first outer annular member end portion 254. In at least one embodiment, the first outer annular member end portion 254 may define a plurality of holes 260 through which a respective fastener 262 may be inserted, thereby coupling the casing 202 and the shroud 234. In another example, the outer annular member 242 may be configured to compliantly mount the shroud 234 to the casing 202 via a radial pilot fit.

As arranged in the compressor 200, the first inner annular member end portion 246 and the first outer annular member end portion 254 are configured to be disposed proximal an eye 264 of the impeller 222. Additionally, the outer annular member 242 and the inner annular member 240 may define an annular cavity 266 therebetween, which may be bounded axially by the casing 202 and the bridge member 244. The annular cavity 266 may be configured to facilitate uniform heating and cooling of the shroud 234 during one or more modes of operating the compressor 200. For example, during one or more modes of operating the compressor 200, the compressor 200 or components thereof (e.g., the impeller 222, the shroud 234, etc.) may experience relatively high and substantially instantaneous temperature changes or thermal transients due to the flow of the hot, compressed process fluid through the compressor 200. The thermal transients may heat separate portions of the shroud 234 at different rates and/or temperatures, and the annular cavity 266 may promote the uniform heating of the shroud 234 during the thermal transients. For example, the annular cavity 266 may promote the uniform heating of the inner annular member 240 and the outer annular member 242 of the shroud 234 during the thermal transients. The annular cavity 266 may also be configured to thermally isolate the inner annular member 240 and the outer annular member 242 from one another.

As shown in FIGS. 2A and 2B, the second annular portion 238 may be coupled with the first annular portion 236 and disposed adjacent the tip 230 of the impeller 222. The second annular portion 238 may include an inner annular surface 268 and an outer annular surface 270. In some embodiments, the inner annular surface 268 of the second annular portion 238 may define a recess 272 extending substantially from the inner annular surface 250 of the first annular portion 236 to the outer annular surface 270 of the second annular portion 238. As arranged, the respective inner annular surfaces 250 and 268 may be disposed adjacent the plurality of blades 226 of the impeller 222, such that during one or more modes of operating the compressor 200, the impeller 222 and the inner annular surfaces 250 and 268 of the shroud 234 may define an impeller clearance 274 therebetween.

The shroud 234 and the casing 202 may define an axial gap 276 and/or a radial gap 278 therebetween. For example, as illustrated in FIG. 2B, the first inner annular member end portion 246 of the inner annular member 240 and the casing 202 may define the axial gap 276 therebetween. In another example, the outer annular surface 270 of the second annular portion 238 and the casing 202 may define the radial gap 278 therebetween.

As illustrated in FIGS. 2A and 2B, each of the first annular portion 236 and the second annular portion 238 may define a plurality of apertures 280, 282 circumferentially disposed about the rotary shaft 108 of the compressor 200. As such, the apertures 280 of the first annular portion 236 may be arranged to align with the respective apertures 282 of the second annular portion 238. As shown in FIGS. 2A and 2B, the apertures 280 may be defined by the bridge member 244 of the first annular portion 236 and may be through holes, and the apertures 282 defined by the second annular portion 238 may be blind holes. A plurality of fasteners 284 may be inserted through the respective aligned apertures 280 and 282 of the first annular portion 236 and the second annular portion 238, thereby coupling the first annular portion 236 and the second annular portion 238 with one another. The plurality of fasteners 284 may be or include mechanical fasteners, such as, for example, bolts. Other illustrative fasteners 284 may include, but are not limited to, pins and screws.

In one embodiment, the plurality of annular portions (two shown 236, 238 in FIGS. 2A and 2B) of the shroud 234 may be constructed from the same material. In another embodiment, at least one of the annular portions of the plurality of annular portions may be constructed from a different material than the material of at least one other annular portion. In yet another embodiment, each annular portion of the plurality of annular portions of the shroud 234 may be constructed from a different material. Additionally, one or more of the annular portions may have a coating (two shown 286, 288 in FIGS. 2A and 2B) disposed thereupon. Accordingly, in one or more embodiments, at least one annular portion may not have a coating disposed thereupon. In one or more other embodiments, each annular portion may have a coating disposed thereupon.

For example, as shown in FIGS. 2A and 2B, the first annular portion 236 and the second annular portion 238 may have respective first and second coatings 286 and 288 disposed thereupon. The first coating 286 disposed on the first annular portion 236 may be disposed in the recess 252 defined by the inner annular surface 250 of the inner annular member 240 of the first annular portion 236. The second coating 288 disposed on the second annular portion 238 may be disposed in the recess 272 defined by the inner annular surface 268 of the second annular portion 238. In an embodiment including a plurality of coatings, each of the coatings may be constructed from the same material. In another embodiment including a plurality of coatings, at least one coating may be constructed from a different material than the material of at least one other coating. In yet another embodiment including a plurality of coatings, each coating may be constructed from a different material.

The material chosen for each of the annular portions and the coating(s) disposed on one or more of the annular portions may be dependent on the location of each annular portion in the shroud 234 within the compressor 200. For example, thermal growth, shroud surface flowpath erosion, and impeller contact may vary depending on the location of the annular portion in the shroud 234 within the compressor 200 and the operating characteristics of the compressor 200. Therefore, it may be desirable in certain locations in the shroud 234 to protect more against shroud surface flowpath erosion due to the effect of the process fluid flowing therethrough at that location. However, in other locations in the shroud 234, it may be desirable to protect more against impeller contact with the shroud 234 at that location. Still further, in other locations, it may be desirable to provide suitable resistance to undesirable thermal growth of the casing 202 and/or the shroud 234. By varying the material of the annular portions and any coating disposed thereupon within the shroud 234 depending of the location of the annular portions within the shroud 234, the performance and longevity of the shroud 234 may be improved.

Based on the foregoing, the first annular portion 236, the second annular portion 238, the first coating 286 disposed on the first annular portion 236, and the second coating 288 disposed on the second annular portion 238 as shown in FIGS. 2A and 2B may be constructed from respective materials depending on the location thereof in the shroud 234 within the compressor 200 and the operating characteristics of the compressor 200. Although the shroud 234 is provided herein for use with the compressor 200, it will be appreciated that the shroud 234 as disclosed may be utilized in other compressors and is not limited to the configuration of the compressor 200. The respective material chosen for each of the first annular portion 236, the second annular portion 238, the first coating 286, and the second coating 288 may be based, for example, on factors including, but not limited to, the properties of the material in relation to thermal growth, shroud surface flowpath erosion, and impeller contact. For example, in locations within the shroud 234 susceptible to contact with the impeller 222, the material chosen for the annular portion(s) 236, 238 and/or coating(s) disposed 286, 288 thereupon may be an abradable material configured to reduce a leakage flow of the process fluid through the impeller clearance 274.

The abradable material may be configured to be deformed, cut, scraped, or otherwise worn down by at least a portion of the impeller 222 to thereby reduce the impeller clearance 274. For example, during one or more modes of operating the compressor 200, the impeller 222 may be rotated such that the plurality of blades 226 of the impeller 222 may incidentally contact the abradable material, thereby scraping or wearing away a sacrificial amount or portion of the abradable material. In at least one embodiment, the abradable material may be provided as the first coating 286 and/or the second coating 288 on at least a portion of the shroud 234. In embodiments in which at least one of the annular portions does not include a coating disposed thereupon, at least one of the annular portion(s) may be constructed from the abradable material.

In one or more embodiments, the abradable material may be provided as the first coating 286 disposed in the recess 252 of the first annular portion 236 and/or the second coating 288 disposed in the recess 272 of the second annular portion 238. The abradable material may have any thickness suitable for reducing the leakage flow of the process fluid through the impeller clearance 274. The abradable material may protrude, project, or otherwise extend from the respective recesses 252 and 272 defined by the inner annular surfaces 250 and 268 of the first annular portion 236 and the second annular portion 238. In at least one embodiment, the abradable material may gradually extend from the recess 252 from the first inner annular member end portion 246 to the second inner annular member end portion 248 of the inner annular member 240. For example, the thickness of the abradable material near or proximal the first inner annular member end portion 246 may be relatively less than the thickness of the abradable material proximal the second inner annular member end portion 248. In another embodiment, the abradable material may gradually extend from the recess 252 from the second inner annular member end portion 248 to the first inner annular member end portion 246 of the inner annular member 240. For example, the thickness of the abradable material proximal the second inner annular member end portion 248 may be relatively less than the thickness of the abradable material proximal the first inner annular member end portion 246. In yet another embodiment, the abradable material may project from the recess 252 in a stepwise manner.

The abradable material may include or be fabricated from any abradable material known in the art. For example, the abradable material may include or be fabricated from one or more metals or metal alloys, one or more polymers, one or more inorganic materials, or any mixture of combination thereof. Illustrative polymers may include, but are not limited to, polyolefin-based polymers, acryl-based polymers, polyurethane-based polymers, ether-based polymers, polyester-based polymers, polyamide-based polymers, formaldehyde-based polymers, silicon-based polymers, or any combination thereof. For example, the polymers may include, but are not limited to, poly(ether ketone) (PEEK), TORLON®, polytetrafluoroethylene (PTFE), polychlorotrifluoroethylene (PCTFE), or any combination or copolymers thereof. Illustrative metals may include, but are not limited to, one or more alkali metals, one or more alkaline earth metals, one or more post-transition metals, one or more transition metals, or any mixtures, alloys, or compounds thereof. For example, the metals may include stainless steel, aluminum, an aluminum alloy, titanium, a titanium alloy, stainless steel, carbon steel, or the like, or any combination thereof. The metals may also include one or more porous metals. Illustrative inorganic materials may include, but are not limited to, one or more ceramics, one or more metal oxides, quartz, mica, alumina-silica, silicon dioxide, or any mixture or combination thereof.

Turning now to locations within the shroud 234 susceptible to shroud surface flowpath erosion, the material chosen for the annular portion(s) and/or coating(s) disposed thereupon may be an erosion resistant material configured to prevent or substantially reduce erosion of the shroud 234. The erosion resistant material may be configured to withstand the impacts of solid particles and/or liquid droplets suspended or otherwise contained in the process fluid flowing through the impeller 222. In at least one embodiment, the erosion resistant material may be provided as the first coating 286 and/or the second coating 288 on at least a portion of the shroud 234. In embodiments in which at least one of the annular portions does not include a coating disposed thereupon, at least one of the annular portions may be constructed from the erosion resistant material.

In one or more embodiments, the erosion resistant material may be provided as the first coating 286 disposed in the recess 252 of the first annular portion 236 and/or the second coating 288 disposed in the recess 272 of the second annular portion 238. The erosion resistant material may have any thickness suitable for reducing the leakage flow of the process fluid through the impeller clearance 274. The erosion resistant material may protrude, project, or otherwise extend from the respective recesses 252 and 272 defined by the inner annular surfaces 250 and 268 of the first annular portion 236 and the second annular portion 238. In at least one embodiment, the erosion resistant material may gradually extend from the recess 252 from the first inner annular member end portion 246 to the second inner annular member end portion 248 of the inner annular member 240. For example, the thickness of the erosion resistant material near or proximal the first inner annular member end portion 246 may be relatively less than the thickness of the erosion resistant material proximal the second inner annular member end portion 248. In another embodiment, the erosion resistant material may gradually extend from the recess 252 from the second inner annular member end portion 248 to the first inner annular member end portion 246 of the inner annular member 240. For example, the thickness of the erosion resistant material proximal the second inner annular member end portion 248 may be relatively less than the thickness of the erosion resistant material proximal the first inner annular member end portion 246. In yet another embodiment, the erosion resistant material may project from the recess 252 in a stepwise manner.

The erosion resistant material may include or be fabricated from any erosion resistant material known in the art. For example, the erosion resistant material may include or be fabricated from one or more metals or metal alloys. Illustrative metals or metal alloys may include, but are not limited to, a cobalt base alloy, a nickel base alloy, a titanium base alloy, a precipitation hardening stainless steel, or a martensitic stainless steel.

Turning now to locations within the shroud 234 susceptible to thermal growth, the material chosen for the annular portion(s) and/or coating disposed(s) thereupon may be a compliant material configured to permit or allow at least a portion (e.g., the annular portion 290) of the casing 202 to expand, deflect, or otherwise move in any one or more directions while the annular portion(s) remain substantially stationary. Accordingly, in one or more embodiments, the shroud 234 may be compliantly mounted with the casing 202.

For example, as illustrated in FIG. 2B, the first annular portion 236 of the shroud 234 may compliantly mount the shroud 234 with an annular portion 290 of the casing 202. In an exemplary embodiment, the outer annular member 242 of the first annular portion 236 may be compliantly mounted with the annular portion 290 of the casing 202. Accordingly, the outer annular member 242 of the first annular portion 236 may be configured to permit or allow at least a portion (e.g., the annular portion 290) of the casing 202 to expand, deflect, or otherwise move in any one or more directions while the inner annular member 240 remains substantially stationary. The outer annular member 242 of the first annular portion 236 may also be configured to maintain a radial length and/or an axial length of the impeller clearance 274 by allowing at least a portion (e.g., the annular portion 290) of the casing 202 to expand, deflect, or otherwise move in any one or more directions while keeping the inner annular member 240 substantially stationary relative to the impeller 222. The outer annular member 242 may also be configured to allow relatively greater or lesser degrees of movement between the inner annular member 240 and the casing 202 in any of the one or more directions. For example, the outer annular member 242 may allow a relatively greater degree of movement between the inner annular member 240 and the casing 202 in a radial direction (e.g., radially outward and/or radially inward directions) than an axial direction. The outer annular member 242 of the first annular portion 236 may also be configured to resist movement or maintain the position of the inner annular member 240 of the first annular portion 236 in any one or more directions relative to the impeller 222. Accordingly, as further described herein, the outer annular member 242 of the first annular portion 236 may be configured to allow movement between the inner annular member 240 and the casing 202, and restrict or resist movement between the inner annular member 240 and the impeller 222.

As noted above, in locations within the shroud susceptible to thermal growth, the annular portion(s) and/or coating(s) disposed thereupon may be fabricated from a compliant material. For example, the second inner annular member end portion 248 of the inner annular member 240 may be fabricated from the compliant material. In another example, the outer annular member 242 or a portion thereof may be fabricated from the compliant material. In another embodiment, the shroud 234 may be shaped and/or sized to compliantly mount the inner annular member 240 with the casing 202. For example, one or more dimensions (e.g., a thickness, length, height) of the outer annular member 242 may be increased to correspondingly decrease the compliance or flexibility thereof. In another example, the dimensions of the outer annular body 242 may be decreased to correspondingly increase the compliance or flexibility thereof. In another example, the annular cavity 266 may be configured to vary (i.e., increase or decrease) the compliance between the shroud 234 and the casing 202. In another embodiment, the shroud 234 may be coupled with the casing 202 via a compliant mount (not shown). For example, the shroud 234 may be coupled with the casing 202 via a compliant mechanical fastener (not shown) configured to allow the casing 202 and the outer annular member 242 coupled therewith to flex or move relative to the inner annular member 240 disposed proximal the impeller 222. In yet another embodiment, an annular portion of the shroud 234 may be fabricated from a material with a different coefficient of thermal expansion than the casing 202. For example, at least an annular portion of the shroud 234 may be fabricated from a material having a coefficient of thermal expansion that is greater than or less than the annular portion 290 of the casing 202.

Accordingly, in one embodiment, the first annular portion 236 may be constructed from a first material, the second annular portion 238 may be constructed from a second material, and the first coating 286 disposed on the first annular portion 238 may be constructed from a third material. At least one of the first material, the second material, and the third material may be different from the remaining first material, second material, and third material. In another embodiment, the first material may be different from the second material, and the third material may be different from at least one of the first material and the second material. In an embodiment, at least one of the second material and the third material may be or include an erosion resistant material. In another embodiment, at least one of the second material and the third material may be or include an abradable material. In yet another embodiment, at least one of the first material and the second material may be or include a compliant material.

In another embodiment, the first annular portion 236 may be constructed from a first material, the second annular portion 238 may be constructed from a second material, the first coating 286 disposed on the first annular portion 236 may be constructed from a third material, and the second coating 288 may be disposed on the second annular portion 238 and may be constructed from a fourth material. At least one of the first material, the second material, the third material, and the fourth material may be different from the remaining first material, second material, third material, and fourth material. In another embodiment, the first material may be different from the second material, and at least one of the third material and the fourth material may be different from at least one of the first material and the second material. In another embodiment, the third material may be different from the fourth material, and at least one of the first material and the second material may be different from at least one of the third material and the fourth material. In an embodiment, at least one of the third material and the fourth material may be or include an erosion resistant material. In another embodiment, at least one of the third material and the fourth material may be or include an abradable material. In yet another embodiment, at least one of the first material and the second material may be or include a compliant material.

In addition to the material chosen for the construction of the shroud 234, the position of the shroud 234 relative to the impeller 222 may be varied to control a size of the impeller clearance 274 defined between the shroud 234 and the impeller 222. In an exemplary embodiment, the position of the shroud 234 relative to the impeller 222 may be varied during one or more modes of operating the compressor 200. For example, during one or more modes of operating the compressor 200, the axial position and/or radial position of the shroud 234 relative to the impeller 222 may be varied to increase or decrease the impeller clearance 274. As further described herein, the impeller clearance 274 may be increased to preserve at least a portion of the abradable material during one or more modes (e.g., startup) of operating the compressor 200.

In at least one embodiment, the position of the shroud 234 relative to the impeller 222 may be varied or controlled via an external device or assembly (not shown). For example, the position of the shroud 234 relative to the impeller 222 may be controlled by an external control system (not shown) configured to actuate or move the shroud 234. The external control system (not shown) may be disposed outside of the casing 202 and configured to control an actuating assembly (e.g., system of linkages) operably coupled with the shroud 234 to axially and/or radially position the shroud 234. The actuating assembly (not shown) may engage the first outer annular member end portion 254 of the outer annular member 242 and/or the first inner annular member end portion 246 of the inner annular member 240 to move or bias the shroud 234 axially toward the impeller 222. In another example, the actuating assembly may engage the second inner annular member end portion 248 of the inner annular member 240 to move or bias the shroud 234 radially relative to the impeller 222.

In another embodiment, the position of the shroud 234 relative to the impeller 222 may be varied or controlled via an internal device or assembly. For example, the position of the shroud 234 relative to the impeller 222 may be varied with one or more shims (two are shown 292). For example, as illustrated in FIG. 2B, the shims 292 may be interposed between the outer annular member 242 of the shroud 234 and the casing 202. The shims 292 may also be interposed between the inner annular member 240 and the casing 202. For example, the shims 292 may be disposed in the axial gap 276 between the first inner annular member end portion 246 of the inner annular member 240 and the casing 202 (e.g., in the axial gap 276). In another example, the shims 292 may be disposed in the radial gap 278 between the second inner annular member end portion 248 and the casing 202 (e.g., in the radial gap 278).

In an exemplary operation of the compressor 200, with continued reference to FIGS. 2A and 2B, the driver 104 (see FIG. 1) may drive the compressor 200 from rest to the steady state mode of operation by accelerating or rotating the rotary shaft 108 (via the drive shaft 106), the impeller 222, and the balance piston 232 coupled therewith. The impeller 222 and the balance piston 232 may rotate relative to the balance piston seal and about the longitudinal axis 228. The acceleration and/or rotation of the impeller 222 may draw the process fluid into the compressor 200 via the inlet passageway 206. The inlet guide vanes 216 disposed in the inlet passageway 206 may induce one or more flow properties (e.g., swirl) to the process fluid flowing therethrough. The rotation of the impeller 222 may further draw the process fluid from the inlet passageway 206 to and through the rotating impeller 222, and urge the process fluid to the tip 230 of the impeller 222, thereby increasing the velocity (e.g., kinetic energy) thereof. The process fluid from the impeller 222 may be discharged from the tip 230 thereof and directed to the diffuser 210 fluidly coupled therewith. The diffuser 210 may receive the process fluid from the impeller 222 and convert the velocity (e.g., kinetic energy) of the process fluid from the impeller 222 to potential energy (e.g., increased static pressure). The diffuser 210 may direct the process fluid downstream to the volute 212 fluidly coupled therewith. The volute 212 may collect the process fluid and deliver the process fluid to one or more downstream pipes and/or process components (not shown). The volute 212 may also be configured to increase the static pressure of the process fluid flowing therethrough by converting the kinetic energy of the process fluid to increased static pressure.

At rest, the impeller 222 may lean or be deflected downward. The downward deflection of the impeller 222 may result in incidental contact between lower portions of the impeller 222 and the shroud 234. Accordingly, a coating constructed from abradable material may be disposed on an annular portion of the shroud 234 at the location of impeller contact. Driving the compressor 200 from rest to the steady state while the impeller 222 and the shroud 234 incidentally contact one another may increase the impeller clearance 274, as the plurality of blades 226 may remove an excess amount or portion of the coating constructed from the abradable material. Accordingly, the position of the shroud 234 may be adjusted or positioned away from the impeller 222 (e.g., via the internal or external assemblies) to thereby increase the impeller clearance 274 and prevent incidental contact between the impeller 222 and the shroud 234. As the compressor 200 reaches the steady state or full speed, the shroud 234 may be urged toward (e.g., axially and/or radially) the impeller 222 (e.g., via the internal or external assemblies) and the plurality of blades 226 may rotate and cut a sacrificial portion of the portion of the coating constructed from the abradable material. The plurality of blades 226 may cut a sacrificial portion of the portion of the coating constructed from the abradable material to contour or shape the coating constructed from the abradable material and conform the coating constructed from the abradable material to the silhouette of the plurality of blades 226, thereby reducing the impeller clearance 274 to substantially zero.

During one or more modes of operation, one or more portions of the casing 202 may thermally expand or grow (e.g., axially and/or radially). For example, compressing the process fluid in the compressor 200 may generate heat or thermal energy (e.g., heat of compression), and the heat generated may be absorbed by one or more portions of the casing 202, thereby resulting in thermal expansion of the portions of the casing 202. In an exemplary embodiment, the heat generated in the compressor 200 may result in the thermal expansion of the annular portion 290 of the casing 202. For example, the annular portion 290 of the casing 202 may absorb at least a portion of the heat generated in the compressor 200 to thereby thermally expand (e.g., radially and/or axially). The radial expansion of the annular portion 290 may exert a biasing force on the shroud 234. For example, the radial expansion of the annular portion 290 may exert a biasing force on the outer annular body 242 of the shroud 234 coupled therewith, as indicated by arrow 294. The biasing force 294 may deflect, move, or otherwise bend the outer annular member 242 of the shroud 234 in a radially outward direction. As previously discussed, one or more annular portions or components thereof forming the shroud 234 may be fabricated from a compliant material. For example, the outer annular member 242 or a portion thereof may be fabricated from the compliant material, or the second inner annular member end portion 248 of the inner annular member 240 may be fabricated from the compliant material. Accordingly, the outer annular member 242 of the shroud 234 may deflect or flex radially outward while the inner annular member 240 remains substantially stationary. The outer annular member 242 of the shroud 234 may be configured to compliantly deflect, flex, expand, or otherwise move with the thermal expansion of the annular portion 290 of the casing 202 coupled therewith while the inner annular member 240 of the shroud 234 remains substantially stationary relative to the impeller 222 to thereby maintain the impeller clearance 274. It should be appreciated that compliantly mounting the shroud 234 with the casing 202 may facilitate the alignment and/or concentricity between the shroud 234 and the impeller 222 to thereby control the impeller clearance 274 therebetween. The shroud 234 described herein may be configured to facilitate the alignment and/or concentricity between the shroud 234 and the impeller 222 over a wide range of temperatures and rotational speeds.

Further, during one or more modes of operation, solid particles (such as sand grains) and/or liquid droplets remaining after a separation process may be suspended or otherwise contained in the process fluid and may be drawn into the impeller 222. The solid particles and/or liquid droplets may contact the surfaces of the impeller 222 and the shroud 234, thereby causing erosion of the shroud 234 and/or impeller 222 at the locations of contact. Accordingly, at such locations within the shroud 234, the annular portion(s) and/or the coating(s) disposed thereupon may be constructed from an erosion resistant material. The erosion resistant material may prevent or at least substantially reduce erosion of the shroud 234 at the locations of contact by the solid particles or liquid droplets in the process fluid, thereby retaining the contour or shape of the annular portion(s) and/or coating(s) constructed from the erosion resistant material to the silhouette of the plurality of blades 226, thereby retaining the desired impeller clearance 274.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We claim:

1. A shroud for a compressor, comprising:
a first annular portion constructed of a first material;
a second annular portion coupled to the first annular portion and constructed of a second material; and
a first coating disposed on the first annular portion and constructed of a third material,
wherein at least one of the first material, the second material, and the third material is a different material from at least one other of the first material, the second material, and the third material.

2. The shroud of claim 1, wherein the first annular portion comprises:
an inner annular member having a first inner annular member end portion and a second inner annular member end portion and an inner annular surface extending between the first inner annular member end portion and the second inner annular member end portion, the first coating being disposed on the inner annular surface of the inner annular member;
an outer annular member having a first outer annular member end portion and a second outer annular member end portion and an outer annular surface extending between the first outer annular member end portion and the second outer annular member end portion, the outer annular member configured to couple the shroud with a casing of the compressor; and
a bridge member extending radially between the second inner annular member end portion and the second outer annular member end portion.

3. The shroud of claim 2, wherein the outer annular member and the inner annular member define an annular cavity therebetween, the annular cavity configured to facilitate uniform heating and cooling of the shroud.

4. The shroud of claim 2, wherein the inner annular surface of the first annular portion is configured to be disposed proximal an impeller of the compressor such that the inner annular member and the impeller define an impeller clearance therebetween.

5. The shroud of claim 4, wherein the first inner annular member end portion and the first outer annular member end portion are configured to be disposed proximal an eye of the impeller.

6. The shroud of claim 2, wherein the inner annular surface of the first annular member defines a recess extending substantially between the first inner annular member end portion and the second inner annular member end portion thereof, and the first coating is at least partially disposed in the recess.

7. The shroud of claim 1, wherein the first annular portion and the second annular portion are coupled with one another via one or more mechanical fasteners.

8. The shroud of claim 1, further comprising a second coating disposed on the second annular portion and constructed of a fourth material, wherein at least one of the first material, the second material, the third material, and the fourth material is a different material from at least one other of the first material, the second material, the third material, and the fourth material.

9. The shroud of claim 8, wherein the second annular portion comprises an inner annular surface, the second coating being disposed on the inner annular surface of the second annular portion.

10. The shroud of claim 9, wherein:
the first material is different from the second material, and
at least one of the third material and the fourth material is different from at least one of the first material and the second material.

11. The shroud of claim 9, wherein:
the third material is different from the fourth material, and
at least one of the first material and the second material is different from at least one of the third material and the fourth material.

12. The shroud of claim 1, wherein:
the first material is different from the second material, and
the third material is different from at least one of the first material and the second material.

13. A shroud for a compressor, comprising:
a first annular portion constructed of a first material and comprising
an inner annular member having a first inner annular member end portion and a second inner annular member end portion and an inner annular surface extending between the first inner annular member end portion and the second inner annular member end portion;
an outer annular member having a first outer annular member end portion and a second outer annular member end portion and an outer annular surface extending between the first outer annular member end portion and the second outer annular member end portion, the outer annular member configured to couple the shroud with a casing of the compressor; and
a bridge member extending radially between the second inner annular member end portion and the second outer annular member end portion;
a second annular portion constructed of a second material and coupled to the first annular portion, the second annular portion comprising an inner annular surface;
a first coating constructed of a third material and disposed on the inner annular surface of the inner annular member; and
a second coating constructed of a fourth material and disposed on the inner annular surface of the second annular portion,
wherein at least one of the first material, the second material, the third material, and the fourth material is a different material from at least one other of the first material, the second material, the third material, and the fourth material.

14. The shroud of claim 13, wherein at least one of the third material and the fourth material is an abradable material.

15. The shroud of claim 13, wherein at least one of the third material and the fourth material is an erosion-resistant material.

16. The shroud of claim 13, wherein at least one of the first material and the second material is a compliant material.

17. A compressor, comprising:
a casing;
a rotary shaft disposed in the casing and configured to be driven by a driver;
an impeller coupled with and configured to be driven by the rotary shaft, the impeller comprising an eye, a tip, and a plurality of blades forming a plurality of flowpaths extending between the eye and the tip of the impeller;
a shroud disposed proximal the impeller and comprising:
a first annular portion constructed of a first material and disposed proximal the eye of the impeller;
a second annular portion coupled to the first annular portion and constructed of a second material, the second annular portion disposed proximal the tip of the impeller; and
a first coating disposed on the first annular portion and constructed of a third material,
wherein at least one of the first material, the second material, and the third material is a different material from at least one other of the first material, the second material, and the third material.

18. The compressor claim 17, wherein the shroud further comprises a second coating disposed on the second annular portion and constructed of a fourth material, wherein at least one of the first material, the second material, the third material, and the fourth material is a different material from at least one other of the first material, the second material, the third material, and the fourth material.

19. The compressor of claim 17, wherein the first annular portion comprises:
an inner annular member having a first inner annular member end portion and a second inner annular member end portion and an inner annular surface extending between the first inner annular member end portion and the second inner annular member end portion, the first coating being disposed on the inner annular surface of the inner annular member;
an outer annular member having a first outer annular member end portion and a second outer annular member end portion and an outer annular surface extending between the first outer annular member end portion and the second outer annular member end portion, the outer annular member configured to couple the shroud with a casing of the compressor; and
a bridge member extending radially between the second inner annular member end portion and the second outer annular member end portion, the bridge member defining a plurality of openings disposed circumferentially about the rotary shaft.

20. The compressor claim 19, wherein:
the first annular portion and the second annular portion are coupled with one another via a plurality of mechanical fasteners, each mechanical fastener extending through a respective opening defined by the bridge member.
